(19) United States
(12) Patent Application Publication
(10) Pub. No.: US 2019/0150140 A1
(43) Pub. Date: May 16, 2019

(54) REPETITION-BASED TRANSMISSIONS AND HYBRID AUTOMATIC REPEAT REQUEST RETRANSMISSIONS

(71) Applicant: QUALCOMM Incorporated, San Diego, CA (US)

(72) Inventors: Shimman Arvind Patel, San Diego, CA (US); Seyedkianoush Hosseini, San Diego, CA (US); Wanshi Chen, San Diego, CA (US)

(21) Appl. No.: 16/105,657

(22) Filed: Aug. 20, 2018

Related U.S. Application Data
(60) Provisional application No. 62/586,863, filed on Nov. 15, 2017.

(51) Int. Cl. H04W 72/04; H04L 1/00; H04W 72/14; H04L 1/18

(52) U.S. Cl. CPC H04W 72/0446; H04L 1/1812; H04W 72/14; H04L 1/0003

(57) ABSTRACT

Methods, systems, and devices for wireless communications are described. To satisfy a (block error rate) BLER target for a transmission of a transport block while limiting latency (e.g., keeping latency within a latency budget), base stations and user equipments (UEs) may support techniques for utilizing repetition-based transmissions of the transport block in combination with hybrid automatic repeat request (HARQ) retransmissions of the transport block. That is, base stations and UEs may support techniques for transmitting multiple repetitions (i.e., copies) of the transport block without first receiving HARQ feedback, in addition to retransmitting one or more copies of the transport block when a receiving device fails to successfully decode at least one of the originally transmitted copies of the transport block (as indicated through HARQ feedback).

### CROSS REFERENCES

The present application for patent claims the benefit of U.S. Provisional Patent Application No. 62/586,863 by PATEL, et al., entitled “REPETITION-BASED TRANSMISSIONS AND HYBRID AUTOMATIC REPEAT REQUEST RETRANSMISSIONS,” filed Nov. 15, 2017, assigned to the assignee hereof, and expressly incorporated by reference herein.

### BACKGROUND

The following relates generally to wireless communication and more specifically to repetition-based transmissions and hybrid automatic repeat request (HARQ) retransmissions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as a Long Term Evolution (LTE) systems or LTE-Advanced (LTE-A) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM).

A wireless multiple-access communications system may include a number of base stations or network access nodes, each simultaneously supporting communication for multiple communication devices, which may be otherwise known as user equipment (UE). Some wireless communications systems may support different types of communications between base stations and UEs (e.g., different types of low latency communications), where each type of communication may be associated with a different latency budget and block error rate (BLER) target. The BLER target may correspond to a reliability target for a certain type of communications, and the latency budget may correspond to a time delay that can be tolerated for a certain type of communications. In some cases, however, it may be challenging for base stations and UEs to satisfy a BLER target for a transmission associated with a particular type of communications while limiting latency (e.g., remaining within a latency budget) and limiting the amount of resources used for the transmission.

### SUMMARY

Some wireless communications systems may support different types of communications between base stations and user equipments (UEs), where each type of communication may be associated with a different latency budget and block error rate (BLER) target. As described herein, to satisfy a BLER target for a transmission of a transport block while limiting latency (e.g., keeping latency within a latency budget), base stations and UEs may support techniques for utilizing repetition-based transmissions of the transport block in combination with hybrid automatic repeat request (HARQ) retransmissions of the transport block. That is, base stations and UEs may support techniques for transmitting multiple repetitions (i.e., copies) of the transport block without first receiving HARQ feedback, in addition to retransmitting one or more copies of the transport block when a receiving device fails to successfully decode at least one of the originally transmitted copies of the transport block, as indicated through HARQ feedback.

A method for wireless communication is described. The method may include identifying one or more transmission time intervals (TTIs) allocated for a transmission of a transport block, transmitting a plurality of copies of the transport block on resources of the one or more TTIs, receiving feedback indicating that at least one copy of the plurality of copies of the transport block was not successfully decoded, and retransmitting one or more copies of the transport block based at least in part on receiving the feedback.

An apparatus for wireless communication is described. The apparatus may include means for identifying one or more TTIs allocated for a transmission of a transport block, means for transmitting a plurality of copies of the transport block on resources of the one or more TTIs, means for receiving feedback indicating that at least one copy of the plurality of copies of the transport block was not successfully decoded, and means for retransmitting one or more copies of the transport block based at least in part on receiving the feedback.

Another apparatus for wireless communication is described. The apparatus may include a processor, memory in electronic communication with the processor, and instructions stored in the memory. The instructions may be operable to cause the processor to identify one or more TTIs allocated for a transmission of a transport block, transmit a plurality of copies of the transport block on resources of the one or more TTIs, receive feedback indicating that at least one copy of the plurality of copies of the transport block was not successfully decoded, and retransmit one or more copies of the transport block based at least in part on receiving the feedback.

A non-transitory computer-readable medium for wireless communication is described. The non-transitory computer-readable medium may include instructions operable to cause a processor to identify one or more TTIs allocated for a transmission of a transport block, transmit a plurality of copies of the transport block on resources of the one or more TTIs, receive feedback indicating that at least one copy of the plurality of copies of the transport block was not successfully decoded, and retransmit one or more copies of the transport block based at least in part on receiving the feedback.

A method of wireless communication is described. The method may include identifying one or more TTIs allocated for a transmission of a transport block, receiving a plurality of copies of the transport block on resources of the one or more TTIs, attempting to decode each of the plurality of copies of the transport block, transmitting feedback indicating that at least one copy of the plurality of copies of the transport block was not successfully decoded, and receiving a retransmission of one or more copies of the transport block based at least in part on transmitting the feedback.

An apparatus for wireless communication is described. The apparatus may include means for identifying one or more TTIs allocated for a transmission of a transport block, means for receiving a plurality of copies of the transport block on resources of the one or more TTIs, means for attempting to decode each of the plurality of copies of the transport block, means for transmitting feedback indicating that at least one copy of the plurality of copies of the transport block was not successfully decoded, and means for receiving a retransmission of one or more copies of the transport block based at least in part on transmitting the feedback.

Another apparatus for wireless communication is described. The apparatus may include a processor, memory in electronic communication with the processor, and instructions stored in the memory. The instructions may be operable to cause the processor to identify one or more TTIs allocated for a transmission of a transport block, receive a plurality of copies of the transport block on resources of the one or more TTIs, attempt to decode each of the plurality of copies of the transport block, transmit feedback indicating that at least one copy of the plurality of copies of the transport block was not successfully decoded, and receive a retransmission of one or more copies of the transport block based at least in part on transmitting the feedback.

A non-transitory computer-readable medium for wireless communication is described. The non-transitory computer-readable medium may include instructions operable to cause a processor to identify one or more TTIs allocated for a transmission of a transport block, receive a plurality of copies of the transport block on resources of the one or more TTIs, attempt to decode each of the plurality of copies of the transport block, transmit feedback indicating that at least one copy of the plurality of copies of the transport block was not successfully decoded, and receive a retransmission of one or more copies of the transport block based at least in part on transmitting the feedback.

### BRIEF DESCRIPTION OF THE DRAWINGS

FIGS. 1 and 2 illustrate examples of wireless communications systems that support repetition-based transmissions and hybrid automatic repeat request (HARQ) retransmissions in accordance with aspects of the present disclosure;

FIGS. 3A-3C illustrate examples of resources used for transmitting multiple copies of a transport block within transmission time intervals (TTIs) in accordance with aspects of the present disclosure;

FIG. 4 illustrates an example of resources used for providing HARQ feedback using a channel state information (CSI) report in accordance with aspects of the present disclosure;

FIGS. 5A and 5B illustrate examples of resources used for transmitting an uplink grant to a user equipment (UE) for a retransmission of a transport block when a base station finishes processing a copy of a transport block in a last symbol of a three-symbol shortened TTI (sTTI) in accordance with aspects of the present disclosure;

FIG. 6 illustrates an example of a process flow that supports repetition-based transmissions and HARQ retransmissions in accordance with aspects of the present disclosure;

FIGS. 7 and 8 show block diagrams of a device that supports repetition-based transmissions and HARQ retransmissions in accordance with aspects of the present disclosure;

FIG. 9 illustrates a block diagram of a system including a UE that supports repetition-based transmissions and HARQ retransmissions in accordance with aspects of the present disclosure;

FIG. 10 illustrates a block diagram of a system including a base station that supports repetition-based transmissions and HARQ retransmissions in accordance with aspects of the present disclosure;

FIGS. 11 and 12 illustrate methods for repetition-based transmissions and HARQ retransmissions in accordance with aspects of the present disclosure.

### DETAILED DESCRIPTION

Some wireless communications systems may support different types of communications (e.g., enhanced mobile broadband (eMBB) communications, mission critical communications, different types of low latency communications, etc.), where each type of communication may be associated with a block error rate (BLER) target and a latency budget. The BLER target may correspond to a reliability target for a certain type of communications, and the latency budget may correspond to a time delay that can be tolerated for a certain type of communications. As an example, a first type of communications may be associated with a BLER target of 10⁻⁵ and a latency budget of 1 ms (e.g., for a 32-byte packet), and a second type of communications may be associated with a BLER target of 10⁻⁴ and a latency budget of 10 ms (e.g., for a 32-byte packet). Accordingly, it may be appropriate for wireless communications systems to support techniques for satisfying a BLER target for a transport block while not exceeding a latency budget.

To satisfy a BLER target for the transmission of a transport block, some wireless communications systems may support the use of hybrid automatic repeat request (HARQ) retransmissions to increase the likelihood that data is received successfully. However, each retransmission of a transport block in a HARQ scheme may introduce additional latency, and, as a result, the latency budget associated with the transport block may only be able to tolerate a limited number of retransmissions. Accordingly, to avoid the latency of HARQ retransmissions, other wireless communications systems may support techniques for transmitting multiple copies (or repetitions) of a transport block (e.g., repetition-based transmissions) without implementing a HARQ scheme.

In some cases, however, it may be challenging for a transmitting device to identify an appropriate number of copies (or repetitions) of the transport block to transmit while limiting the amount of resources used to transmit the copies of the transport block. For example, if an initial copy of the transport block can be decoded by a receiving device, subsequent retransmissions (or repetitions) of the transport block may be wasteful. Further, it may be challenging for a transmitting device to identify an appropriate amount of resources to use to transmit each copy of the transport block. For example, if a large amount of resources is allocated to transmit each copy of the transport block (e.g., to satisfy a BLER target), such an allocation may limit the amount of resources available to other devices (e.g., since system capacity may be limited), and the performance of a wireless communications system may be degraded.

As described herein, a wireless communications system may support efficient techniques for supporting repetition-based transmissions in combination with HARQ retransmissions to satisfy a BLER target for a transmission of a transport block while limiting latency (e.g., keeping latency within a latency budget) and limiting the amount of resources used to transmit and retransmit the transport block. In particular, a transmitting device may support techniques for transmitting multiple copies (or repetitions) of a transport block without first awaiting HARQ feedback, in addition to retransmitting one or more copies of the transport block if a receiving device fails to decode the originally transmitted copies of the transport block (as indicated through HARQ feedback). In some cases, the transmitting device may transmit the multiple copies of the transport block in groups of symbols in a TTI to reduce the turnaround time associated with HARQ retransmissions, which may reduce the latency associated with the retransmissions and increase the chances of satisfying a BLER target.

Aspects of the disclosure introduced above are described below in the context of a wireless communications system. Examples of processes and signaling exchanges that support repetition-based transmissions and HARQ retransmissions are then described. Aspects of the disclosure are further illustrated by and described with reference to apparatus diagrams, system diagrams, and flowcharts that relate to repetition-based transmissions and HARQ retransmissions.

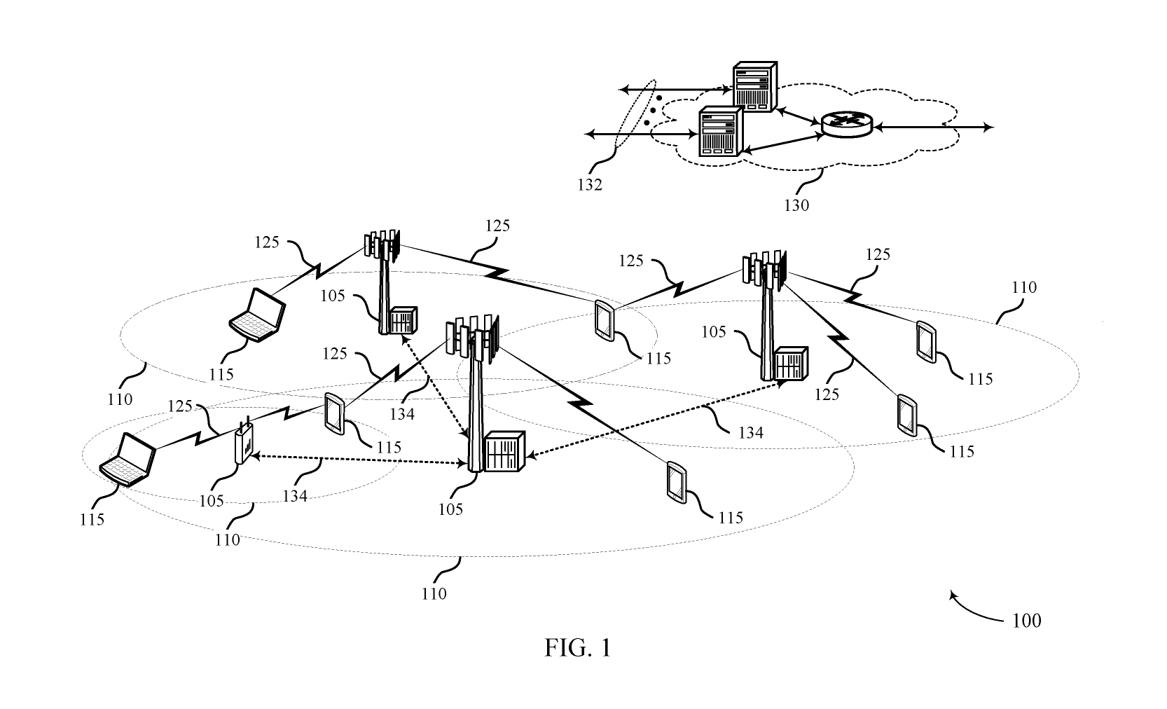

FIG. 1 illustrates an example of a wireless communications system 100 that supports repetition-based transmissions and HARQ retransmissions in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, or a New Radio (NR) network. In some cases, wireless communications system 100 may support eMBB communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use HARQ to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

Time intervals of a communications resource in LTE or NR may be organized according to radio frames each having a duration of 10 milliseconds (ms). The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). In some cases, a subframe may be the smallest scheduling unit of the wireless communications system 100, and may be referred to as a TTI. In other cases, a smallest scheduling unit of the wireless communications system 100 may be shorter than a subframe or may be dynamically selected (e.g., in bursts of shortened TTIs (sTTIs) or in selected component carriers using sTTIs).

As mentioned above, wireless communications system 100 may support different types of communications (e.g., eMBB communications, mission critical communications, different types of low latency communications, etc.), where each type of communication may be associated with a BLER target and a latency budget. To satisfy a BLER target for the transmission of a transport block associated with a certain type of communications, some wireless communications system may implement a HARQ scheme to increase the likelihood that data is received successfully. In HARQ, when a receiving device fails to receive data transmitted by a transmitting device, the receiving device may transmit a negative acknowledgement (NACK) (e.g., as opposed to an acknowledgement (ACK)) to a transmitting device to indicate that the receiving device failed to successfully decode the data. The transmitting device may then retransmit the data to the receiving device. However, each retransmission of a transport block in a HARQ scheme may introduce additional latency, and, as a result, the latency budget associated with the transport block may only be able to tolerate a limited number of retransmissions (e.g., zero, in some cases).

As an example, a base station 105 may transmit a transport block to a UE 115 in a two-symbol sTTI (e.g., in sTTI n). The UE 115 may then receive and attempt to decode the transport block. In some cases, the UE 115 may fail to decode the transport block, and the UE 115 may transmit a NACK, to the base station 105, four sTTIs after receiving the transport block (e.g., in sTTI n+4). The base station 105 may process the NACK and may schedule a retransmission of the transport block four sTTIs later (e.g., in sTTI n+8). The base station 105 may receive the retransmission of the transport block, successfully decode the transport block, and pass the data from the transport block to higher layers for processing two sTTIs after receiving the retransmission (e.g., in sTTI n+10). Thus, the overall delay for the transmission and the retransmission of the transport block may be 1.4 ms (e.g., since the transport block may be successfully decoded after 20 symbols), which may exceed a latency budget associated with the transport block (e.g., 1 ms).

Accordingly, to avoid the latency of HARQ retransmissions, other wireless communications systems may support techniques for transmitting multiple copies (or repetitions) of a transport block (e.g., repetition-based transmissions) without implementing a HARQ scheme. However, it may be challenging for a transmitting device to identify an appropriate number of copies (or repetitions) of the transport block to transmit while limiting the amount of resources used to transmit the transport block. For example, if an initial copy of the transport block can be decoded by a receiving device, subsequent transmissions of the transport block may be wasteful. Wireless communications system 100 may support efficient techniques for utilizing repetition-based transmissions in combination with HARQ retransmissions to satisfy a BLER target for a transmission of a transport block while limiting latency (e.g., keeping latency within a latency budget).

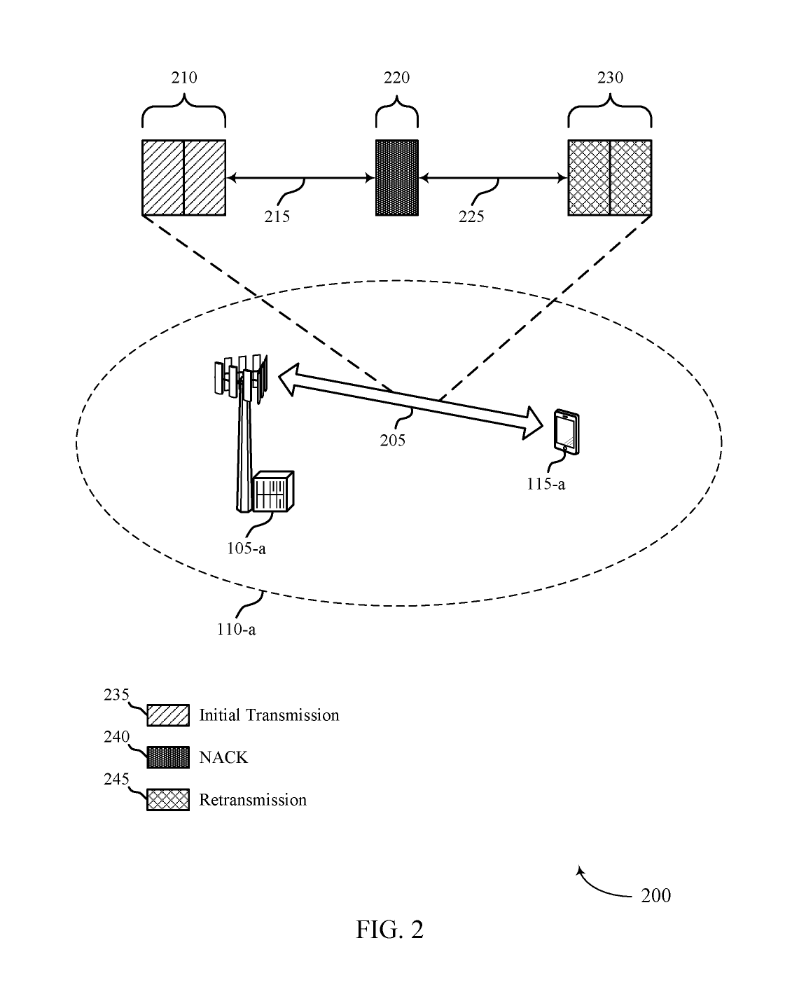

FIG. 2 illustrates an example of a wireless communications system 200 in accordance with various aspects of the present disclosure. Wireless communications system 200 includes base station 105-a and UE 115-a, which may be examples of the corresponding devices described with reference to FIG. 1. Base station 105-a may communicate with UEs 115 (including UE 115-a) within coverage area 110-a. For example, base station 105-a may communicate with UE 115-a on resources of a carrier 205. Wireless communications system 200 may implement aspects of wireless communications system 100. For example, wireless communications system 200 may support efficient techniques for utilizing repetition-based transmissions in combination with HARQ retransmissions to satisfy a BLER target for a transmission of a transport block while limiting latency (e.g., keeping latency within a latency budget). In some aspects, wireless communications system 200 may operate in mmW spectrum.

In one example of FIG. 2 (i.e., for downlink communications), base station 105-a may identify a transport block to transmit to UE 115-a, and base station 105-a may schedule an initial transmission 235 of the transport block to UE 115-a. Base station 105-a may then transmit multiple copies of the transport block to UE 115-a in one or more TTIs 210. In some cases, base station 105-a may transmit an indication to UE 115-a of the number of copies of the transport block being transmitted to UE 115-a. For example, base station 105-a may transmit the indication of the number of copies of the transport block being transmitted to UE 115-a using higher layer signaling, or using the DCI that schedules the initial transmission 235 of the transport block. In addition, base station 105-a may indicate other configurations for each copy of the transport block transmitted to UE 115-a in the initial transmission 235 (e.g., a resource allocation, a redundancy version, a modulation and coding scheme (MCS), etc.) using higher layer signaling, or using the DCI that schedules the transmission of the transport block.

UE 115-a may receive the multiple copies of the transport block and UE 115-a may attempt to decode each copy of the transport block during a time period 215. In some cases, UE 115-a may fail to decode the copies of the transport block, and may transmit a NACK 240 in TTI 220. Base station 105-a may then process the NACK 240 during a time period 225, and base station 105-a may schedule a retransmission 245 of the transport block to UE 115-a. Base station 105-a may then retransmit multiple copies of the transport block to UE 115-a in a set of TTIs 230, and UE 115-a may successfully decode at least one copy of the transport block. In some aspects, a combination of repetition-based transmissions and HARQ retransmissions of the transport block may allow the base station 105-a to satisfy a BLER target associated with the transport block, while limiting latency (e.g., to remain within a latency budget).

In the examples described above, each copy of the transport block may be mapped to a TTI. However, the transmission of a transport block in a TTI may limit the number of HARQ retransmissions that can be supported in wireless communications system 200, which may reduce the chances of satisfying a BLER target. For example, as discussed with reference to FIG. 1, if base station 105-a is configured to communicate with UE 115-a using a two-symbol sTTI, the latency after one retransmission of a transport block (e.g., 1.4 ms) may exceed a latency budget (e.g., 1 ms). As a result, the base station 105-a may not be able to retransmit the transport block, and the BLER target associated with the transport block may not be satisfied.

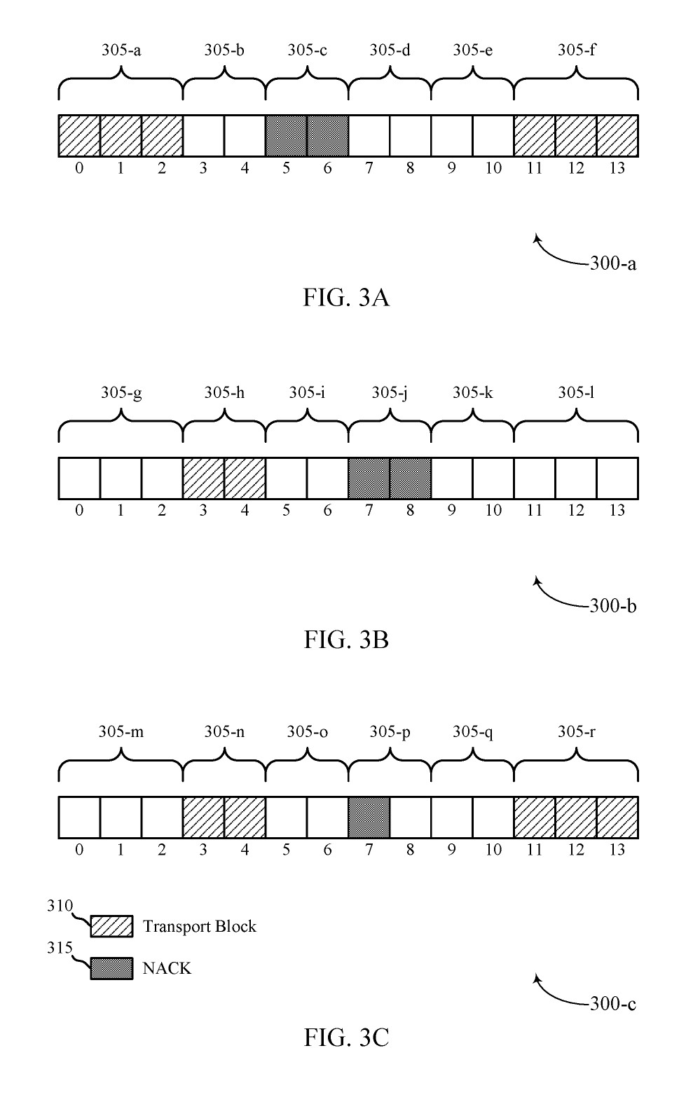

FIGS. 3A-3C illustrate examples of resources 300-a, 300-b, and 300-c used for transmitting multiple copies of a transport block within one or more TTIs in accordance with various aspects of the present disclosure. In some aspects, the techniques described herein may serve to maximize a number of HARQ retransmissions within a latency budget while accommodating repetition-based transmissions.

In the example of FIG. 3A, downlink transmissions from base station 105 and uplink transmissions from UE 115-a may be aligned within sTTIs 305. That is, a downlink transmission from base station 105 may span all symbols in an sTTI 305 allocated for the downlink transmission, and an uplink transmission from UE 115 may span all symbols in an sTTI 305 allocated for the uplink transmission. As illustrated, base station 105 may transmit three copies of a transport block 310 to UE 115 in sTTI 305-a. UE 115 may receive the three copies of the transport block 310 and may attempt to decode each copy of the transport block 310. In some cases, UE 115 may fail to decode each copy of the transport block 310, following which UE 115 may transmit a NACK 315 in sTTI 305-c for the same.

In some cases, base station 105 may process the NACK 315 during sTTIs 305-d and 305-e and may schedule a retransmission of one or more copies of the transport block 310 in sTTI 305-f. Base station 105 may then retransmit the transport block 310 to UE 115 in sTTI 305-f, and UE 115 may successfully decode at least one copy of the transport block 310 retransmitted in sTTI 305-f. Because each copy of the transport block may be transmitted in a symbol of an sTTI 305 rather than an entire sTTI, the time used to process the transport block may be reduced (e.g., from four sTTIs to four symbols). As such, UE 115 may be able to transmit HARQ feedback to base station 105 earlier, and base station 105 may be able to support additional retransmissions of a transport block within a latency budget. For instance, in the example of FIG. 3A, base station 105 may be able to retransmit the transport block 310 within latency budget constraints (e.g., 1 ms).

Although the techniques described above may allow base station 105-a to support additional retransmissions to UE 115, additional latencies may be introduced due to constraints on aligning uplink transmissions in an sTTI (e.g., as discussed with reference to FIG. 3A). For example, although UE 115 may finish processing a first copy of the transport block 310 transmitted in symbol 0 of sTTI 305-a by symbol 4 of sTTI 305-b, UE 115 may wait to transmit a NACK 315 in sTTI 305-c such that the uplink transmission of the NACK 315 is aligned in sTTI 305-c (i.e., rather than transmitting the NACK 315 in symbol 4 of sTTI 305-b). In some examples, the latency associated with waiting to transmit a NACK 315 may limit a number of HARQ retransmissions that can be supported within a latency budget.

In another example, and as further illustrated in FIG. 3B, a base station 105 may identify a transport block 310 to transmit to UE 115 during symbol 0 of sTTI 305-g (e.g., after the start of symbol 0). Further, base station 105 may wait until sTTI 305-h to transmit copies (e.g., two copies) of the transport block 310. Following transmission of the copies of the transport block 310 in sTTI 305-h, UE 115 may process the received copies of the transport block 310 in sTTI 305-i. In some cases, UE 115 may fail to decode a first copy of the transport block 310, and UE 115-a may transmit a NACK 315 for the first copy of the transport block 310 in sTTI 305-j. Base station 105 may then receive the NACK 315 and process the NACK 315 in sTTI 305-k. In some circumstances, the NACK 315 may be transmitted in an uplink transmission aligned in sTTI 305-j (e.g., an uplink transmission that spans all symbols in sTTI 305-j), and base station 105 may not finish processing the NACK 315 until symbol 12 in sTTI 305-1. Thus, base station 105 may not be able to schedule a retransmission of the transport block 310 until a subsequent sTTI (not shown). However, the latency associated with retransmitting the transport block 310 in the subsequent sTTI may exceed a latency budget.

FIG. 3C illustrates an example of techniques for transmitting multiple copies of a transport block within TTIs, where downlink transmissions from base station 105 may be aligned within sTTIs 305 and uplink transmissions from UE 115 may not be aligned within sTTIs 305. For example, a downlink transmission from base station 105 may span all symbols in an sTTI 305 allocated for the downlink transmission, whereas an uplink transmission from UE 115 may span a subset of symbols in an sTTI 305 allocated for the uplink transmission. Because the uplink transmissions from UE 115 may be transmitted in a subset of the symbols in an sTTI, the turnaround time for HARQ feedback from UE 115 may be reduced (i.e., as compared to the turnaround time for HARQ feedback from UE 115, as discussed with reference to FIGS. 3A and 3B).

For instance, in the example of FIG. 3C, if a base station 105 identifies a transport block 310 to transmit to UE 115 during symbol 0 of sTTI 305-m (e.g., after the start of symbol 0), base station 105 may wait until sTTI 305 to transmit copies (e.g., two copies) of the transport block 310. Base station 105 may then transmit the copies of the transport block 310 in sTTI 305-n, and UE 115 may process the received copies of the transport block 310 in sTTI 305-o. As illustrated, in some cases, UE 115 may fail to decode a first copy of the transport block 310, and UE 115 may transmit a NACK 315 for the first copy of the transport block 310 in symbol 7 of sTTI 305-p. That is, UE 115 may transmit the NACK 315 in a subset of the symbols of sTTI 305-p, and the NACK 315 may be self-decodable (i.e., base station 105 may be able to decode the NACK 315 transmitted in the subset of symbols in an sTTI independent of the other symbols in an sTTI). In one example, the NACK 315 may be transmitted in a two-symbol shortened physical uplink control channel (sPUCCH) that includes two frequency hopped symbols, where each of the symbols is self-decodable.

In some cases, base station 105 may receive the NACK 315 in symbol 7 of sTTI 305-p, and base station 105 may process the NACK 315 in symbol 8 of sTTI 305-p and in both symbols of sTTI 305-q. Further, base station 105 may be able to start and finish processing the NACK 315 received in symbol 7 of sTTI 305-p by symbol 11 in sTTI 305-r (e.g., rather than symbol 12 of sTTI 305-r as discussed with reference to FIG. 3B). Subsequently, base station 105 may be able to schedule a retransmission of the transport block 310 in sTTI 305-r, and meet latency budget requirements. In some cases, such techniques for transmitting uplink transmissions (e.g., HARQ feedback) in a subset of symbols in an sTTI may serve to reduce latency in a wireless communications system.

Table 1 below illustrates examples of the timing of various transmissions and retransmissions of a transport block using the techniques described with reference to FIGS. 3A and 3B, related to transmitting an uplink transmission of HARQ feedback in all symbols in an sTTI (i.e., an aligned uplink transmission).

TABLE 1
HARQ timing using aligned uplink transmissions

| | Start | | | Start | | |
|---|---|---|---|---|---|---|
| | of Base | Start | End | of Base | | |
| Packet | Station | of UE | of UE | Station | Decoding | |
| Arrival | Trans- | Trans- | Trans- | Trans- | Success | Total Delay |
| Symbol | mission | mission | mission | mission | Symbol | in Symbols |
| 0 | 3 | 7 | 8 | 14 | 15 | 15 |
| 1 | 3 | 7 | 8 | 14 | 15 | 14 |
| 2 | 3 | 7 | 8 | 14 | 15 | 13 |
| 3 | 5 | 9 | 10 | 14 | 15 | 12 |
| 4 | 5 | 9 | 10 | 14 | 15 | 11 |
| 5 | 7 | 11 | 13 | 17 | 18 | 13 |
| 6 | 7 | 11 | 13 | 17 | 18 | 12 |
| 7 | 9 | 14 | 16 | 21 | 22 | 15 |
| 8 | 9 | 14 | 16 | 22 | 22 | 14 |
| 9 | 11 | 17 | 18 | 23 | 24 | 15 |
| 10 | 11 | 17 | 18 | 23 | 24 | 14 |
| 11 | 14 | 19 | 20 | 25 | 26 | 15 |
| 12 | 14 | 19 | 20 | 25 | 26 | 14 |
| 13 | 14 | 19 | 20 | 25 | 26 | 13 |

Table 2 below illustrates examples of the timing of various transmissions and retransmissions of a transport block using the techniques described with reference to FIG. 3C, related to transmitting an uplink transmission of HARQ feedback in a subset of the symbols in an sTTI (i.e., an unaligned uplink transmission).

TABLE 2
HARQ timing using unaligned uplink transmissions

| | | Start and | | | Total |
|---|---|---|---|---|---|
| Packet | Start of Base | End of UE | Start of Base | Decoding | Delay |
| Arrival | Station | Trans- | Station | Success | in |
| Symbol | Transmission | mission | Transmission | Symbol | Symbols |
| 0 | 3 | 7 | 11 | 12 | 12 |
| 1 | 3 | 7 | 11 | 12 | 11 |
| 2 | 3 | 7 | 11 | 12 | 10 |
| 3 | 5 | 9 | 14 | 15 | 12 |
| 4 | 5 | 9 | 14 | 15 | 11 |
| 5 | 7 | 11 | 17 | 18 | 13 |
| 6 | 7 | 11 | 17 | 18 | 12 |
| 7 | 9 | 14 | 19 | 20 | 13 |
| 8 | 9 | 14 | 19 | 20 | 12 |
| 9 | 11 | 17 | 21 | 22 | 13 |
| 10 | 11 | 17 | 21 | 22 | 12 |
| 11 | 14 | 19 | 23 | 24 | 13 |
| 12 | 14 | 19 | 23 | 24 | 12 |
| 13 | 14 | 19 | 23 | 24 | 11 |

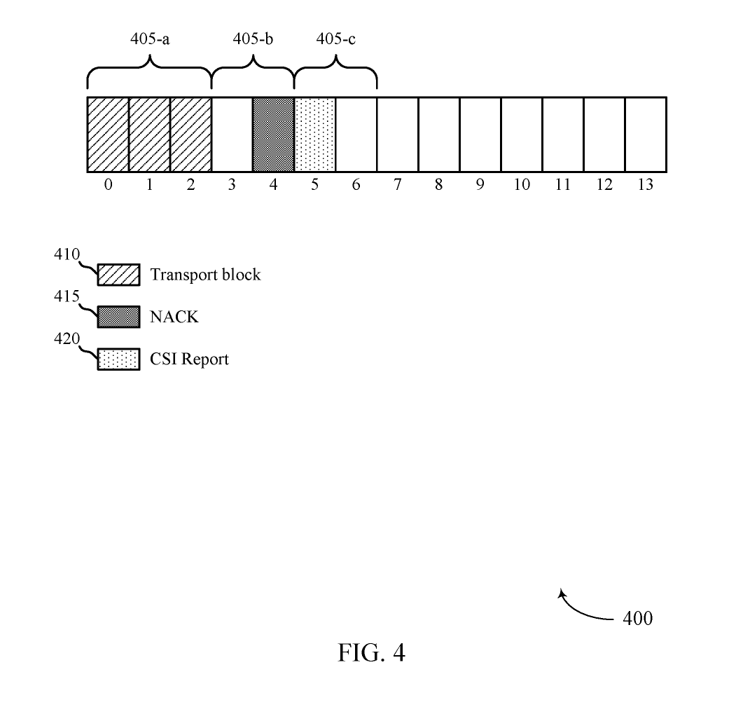

FIG. 4 illustrates an example of resources 400 used for providing HARQ feedback using a channel state information (CSI) report in accordance with various aspects of the present disclosure. In the example of FIG. 4, downlink transmissions from a base station 105 may be aligned within sTTIs 405 (e.g., sTTI 405-a, sTTI 405-b, sTTI 405-c), and uplink transmissions from a UE 115 may be unaligned within sTTIs 405. For instance, a downlink transmission from base station 105 may span all symbols in an sTTI 405 allocated for the downlink transmission, whereas an uplink transmission from UE 115-a may span a subset of the symbols in an sTTI 405 allocated for the uplink transmission.

In the example of FIG. 4, base station 105-a may transmit three copies of a transport block 410 to UE 115 in sTTI 405-a. UE 115-a may receive the first copy of the transport block and may attempt to decode the first copy of the transport block. In some circumstances, the UE 115 may fail to decode the first copy of the transport block and may transmit a NACK 415, to the base station 105, in sTTI 405-b for the same.

In some examples, UE 115 may receive a second copy of the transport block and may attempt to decode it. In some cases, UE 115-a may successfully decode the second copy, based on which it may be appropriate for the UE 115 to transmit an ACK to the base station 105. As described herein, however, instead of transmitting an ACK to base station 105 for the second transport block, the UE 115 may transmit a CSI report 420 in sTTI 405-c for the second transport block. The CSI report 420 may serve as an ACK and may also indicate the channel properties of a communication link (e.g., based on the first and second copies of the transport block received in sTTI 405-a). In some cases, the base station 105 may receive the CSI report 420, and avoid scheduling a retransmission of the transport block 410.

Additionally or alternatively, the base station 105 may use the information included in the CSI report 420 for future scheduling. For instance, the base station 105 may use the CSI report 420 to determine a number of copies of a next transport block to be transmitted, an amount of resources to allocate for the transmission of each copy of the transport block, etc. In some cases, base station 105 may demodulate the CSI report 420 received in sTTI 405-c based on the NACK 415 received in sTTI 405-b. For example, because the NACK 415 may correspond to a cyclic shifted version of a signal, base station 105 may remove the cyclic shift from the received NACK 415 and use the resulting signal to determine an estimate of the channel used to transmit the NACK 415 and the CSI report 420. In some cases, base station 105 may then demodulate the CSI report 420 based on the determined channel estimate.

In some cases, however, UE 115 may fail to decode the second copy of the transport block. In such cases, UE 115 may transmit NACK 415 in symbol 5 of sTTI 405-c (not shown). As described herein, and to provide base station 105 with additional information on the channel properties of a communication link, UE 115 may transmit a CSI report in addition to the NACK in symbol 5 of sTTI 405-c. In some aspects, the base station 105 may determine that the UE 115 failed to successfully decode the second copy of the transport block, based on the NACK and CSI report being included in the same symbol.

In some cases, and in accordance with aspects of the present disclosure, the base station 105 may determine at least one of an estimate of the channel used to transmit the NACK and the CSI report 420 based on the NACK (e.g., the NACK transmitted in symbol 4 of sTTI 405-b or the NACK transmitted in symbol 5 of sTTI 405-c). In some cases, the base station 105 may demodulate the CSI report 420 based on the determined channel estimate. Further, the base station 105 may use the information in the CSI report 420 to schedule retransmissions of the transport block. For example, base station 105 may use the information in the CSI report 420 to determine a number of copies of the transport block to retransmit, an amount of resources to allocate for the retransmission of each copy of the transport block, etc.

Although the techniques described above with reference to FIGS. 4A-4C are directed to a downlink transmission of a transport block, it is to be understood that the above techniques may also be applied to an uplink transmission of a transport block. For example, a UE may transmit multiple copies of a transport block in an sTTI, where each copy is transmitted in a symbol in the sTTI. In this example, the uplink transmission of the transport block may be aligned in the sTTI, and a base station may transmit HARQ feedback to the UE in an aligned downlink transmission (as described with reference to FIGS. 3A and 3B) or an unaligned downlink transmission (as described with reference to FIG. 3C). In one example of an unaligned downlink transmission, a base station completing processing of an uplink transmission of a copy of a transport block in a last symbol of a three-symbol sTTI may be allowed to transmit an uplink grant to the UE 115 in the last symbol of the three-symbol sTTI, in order to schedule a retransmission of the transport block.

In some systems, however, the last symbol of a three-symbol sTTI may not be used for control information (e.g., may not include a shortened physical downlink control channel (sPDCCH)).

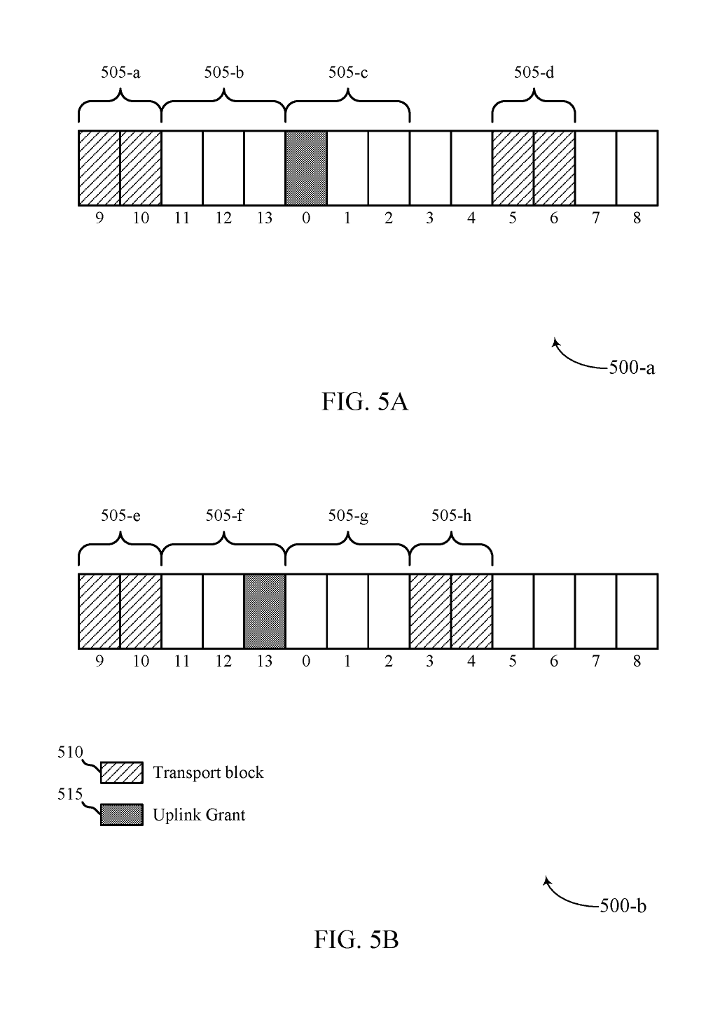

FIGS. 5A and 5B illustrate examples of resources 500-a and 500-b used for transmitting an uplink grant to UE 115 for a retransmission of a transport block when a base station 105 finishes processing a copy of a transport block (e.g., after a failed attempt at decoding the transport block) in a last symbol of a three-symbol sTTI. In the example of FIG. 5A, UE 115 may transmit two copies of a transport block 510 to base station 105 in sTTI 505-a. Base station 105 may receive the two copies of the transport block and may process (e.g., attempt to decode) the two copies of the transport block. In this example, the base station 105 may fail to decode the first copy of the transport block and may finish processing the first copy of the transport block in symbol 13 of sTTI 505-b. However, in some systems, symbol 13 of sTTI 505-b may not be used to transmit control information to UE 115 (i.e., because symbol 13 is the last symbol in sTTI 505-b).

In some cases, to limit the complexity of configuring base station 105 to transmit control information in the last symbol of an sTTI and configuring the UE 115 to monitor the same, the base station 105 may avoid transmitting the uplink grant 515 (i.e., to schedule a retransmission of the transport block) in symbol 13 of sTTI 505-b. Instead, base station 105-a may transmit the uplink grant 515 in symbol 0 of sTTI 505-c. After receiving the uplink grant, UE 115-a may retransmit two copies of the transport block in sTTI 505-d.

In the example of FIG. 5B, a UE 115 may transmit two copies of a transport block to a base station 105 in sTTI 505-e. In some cases, base station 105 may receive the two copies of the transport block and may process (e.g., attempt to decode) the two copies of the transport block. In this example, the base station 105 may fail to decode the first copy of the transport block and may finish processing the first copy of the transport block in symbol 13 of sTTI 505-f.

In some examples, and to limit the latency associated with transmitting an uplink grant 515, the base station 105 may be configured to transmit control information in symbol 13 of sTTI 505-f. Further, UE 115 may be configured to monitor for the control information in sTTI 505-f. Thus, three-symbol sTTIs used for downlink communications may be configured with an sPDCCH in a last symbol of the sTTI. In such cases, the candidates for an sPDCCH for a specific low latency UE may be included in a specific symbol in the sTTI.

In some cases, a base station may transmit control information in an sPDCCH in any symbol of an sTTI to low latency users, while the base station may transmit control information to other users in any of the first two symbols of the sTTI. To ensure that the other users avoid receiving the control information in a last symbol of the sTTI (e.g., receiving and interpreting the control information as data), the base station may avoid allocating the resources used for the sPDCCH to these other users for data transmissions (e.g., as a shortened physical downlink shared channel (sPDSCH)). Accordingly, the base station 105 may transmit the uplink grant 515 in symbol 13 of sTTI 505-f to schedule a retransmission of the transport block. After receiving the uplink grant, the UE 115 may retransmit two copies of the transport block in sTTI 505-h.

Although the examples described above discuss techniques for transmitting multiple copies of a transport block in two-symbol sTTIs and three-symbol sTTIs, it is to be understood that the techniques described above can be used for transmitting multiple copies of a transport block in TTIs having other durations. In such examples, the multiple copies of the transport block may be transmitted in groups of multiple symbols in the TTIs having the other durations (e.g., as opposed a single symbol). For instance, a base station 105 may transmit three copies of a transport block in groups of two symbols in a one-slot sTTI (e.g., spanning six symbols). Similarly, a base station may transmit six copies of a transport block in groups of two symbols in a subframe or two copies of a transport block in the slots in a subframe.

In the examples described above, the HARQ timing may be defined based on the number of symbols in the groups used to transmit each copy of the transport block. For example, if a copy of a transport block is transmitted in a slot of a subframe (e.g., when the subframe is scheduled for the transmission), a receiving device processing the transport block may transmit HARQ feedback for the transport block four slots later. In some examples, the size of the groups of symbols used to transmit the copies of the transport block may be selected based on a BLER target and a latency budget associated with the transport block.

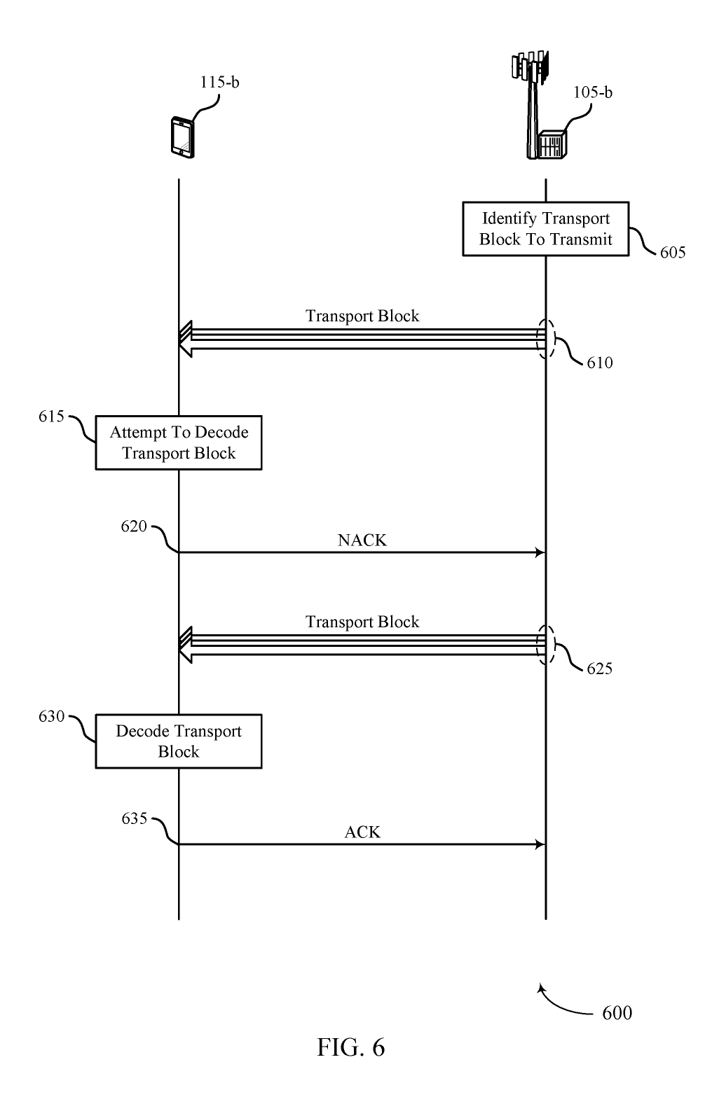

FIG. 6 illustrates an example of a process flow 600 that supports repetition-based transmissions and HARQ retransmissions in accordance with various aspects of the present disclosure. Process flow 600 illustrates aspects of techniques performed by a base station 105-b and a UE 115-b, which may be examples of a base station 105 and a UE 115 as described with reference to FIGS. 1 and 2. Although the techniques described below with reference to FIG. 6 discuss a downlink transmission and retransmission of a transport block, it is to be understood that the same techniques may be applied for uplink transmissions and retransmissions of a transport block.

At 605, base station 105-b may identify a transport block to transmit to UE 115-b. Base station 105-b may also identify one or more TTIs allocated for the transmission of the transport block.

At 610, base station 105-b may transmit multiple (e.g., three) copies of the transport block on resources of the one or more TTIs. In some cases, the base station 105-b may transmit the multiple copies of the transport block in a single TTI, where each copy of the transport block is transmitted on resources of a group of one or more symbols in the single TTI. In some cases, each copy of the transport block transmitted on resources of a group of one or more symbols may be self-decodable.

In some cases, a transmission of a first and second copy of the transport block may be scheduled using DCI transmitted by base station 105-b. In some cases, the DCI may indicate configurations for the transmission of the first transport block and the second transport block. In other cases, the configurations may be indicated by base station 105-b using higher layer signaling. For instance, base station 105-b may transmit RRC signaling to indicate configurations for the transmission of the first and second transport blocks. In some examples, the configurations may correspond to a resource allocation, a redundancy version, an MCS, etc.

At 615, UE 115-b may attempt to decode the multiple copies of the transport block. In this example, the UE 115-b may fail to decode at least one of the copies of the transport block. Accordingly, at 620, UE 115-b may transmit a NACK to the base station 105-b. In some cases, the time taken by UE 115-b to process (e.g., attempt to decode) a copy of the transport block and transmit the NACK may be based on the number of symbols in a group of symbols used to transmit the copy of the transport block. In some examples, the NACK may be transmitted in all symbols in a TTI subsequent to one or more TTIs used to transmit the copies of the transport block at 610. In other examples, the NACK may be transmitted in a subset of the symbols in a TTI subsequent to the one or more TTIs used to transmit the copies of the transport block at 610.

After processing the NACK, base station 105-b may schedule a retransmission of one or more copies of the transport block. For example, the base station 105-b may transmit a downlink grant to UE 115-b to allocate resources for the retransmission of the one or more copies of the transport block. At 625, base station 105-b may then retransmit the one or more copies of the transport block.

In some cases, UE 115-b may receive the one or more copies of the transport block. At 630, the UE 115-b may decode at least one copy of the transport block. In some cases, at 635, UE 115-b may transmit an ACK to base station 105-b for the at least one copy of the transport block. In some cases, rather than transmitting an ACK to base station 105-b, UE 115-b may transmit a CSI report to indicate that the at least one copy of the transport block was successfully decoded. In some aspects, base station 105-b may then demodulate the CSI report based on a channel estimate, where the channel estimate may be determined based on the previously received NACK.

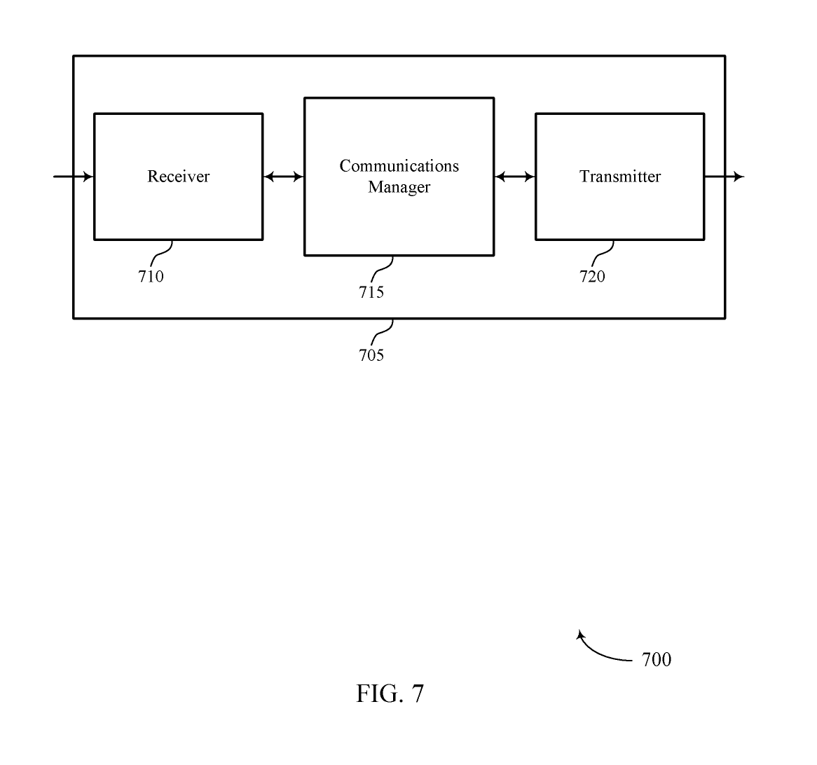

FIG. 7 shows a block diagram 700 of a wireless device 705 that supports repetition-based transmissions and HARQ retransmissions in accordance with aspects of the present disclosure. Wireless device 705 may be an example of aspects of a UE 115 or base station 105 as described herein. Wireless device 705 may include receiver 710, communications manager 715, and transmitter 720. Wireless device 705 may also include a processor. Each of these components may be in communication with one another (e.g., via one or more buses).

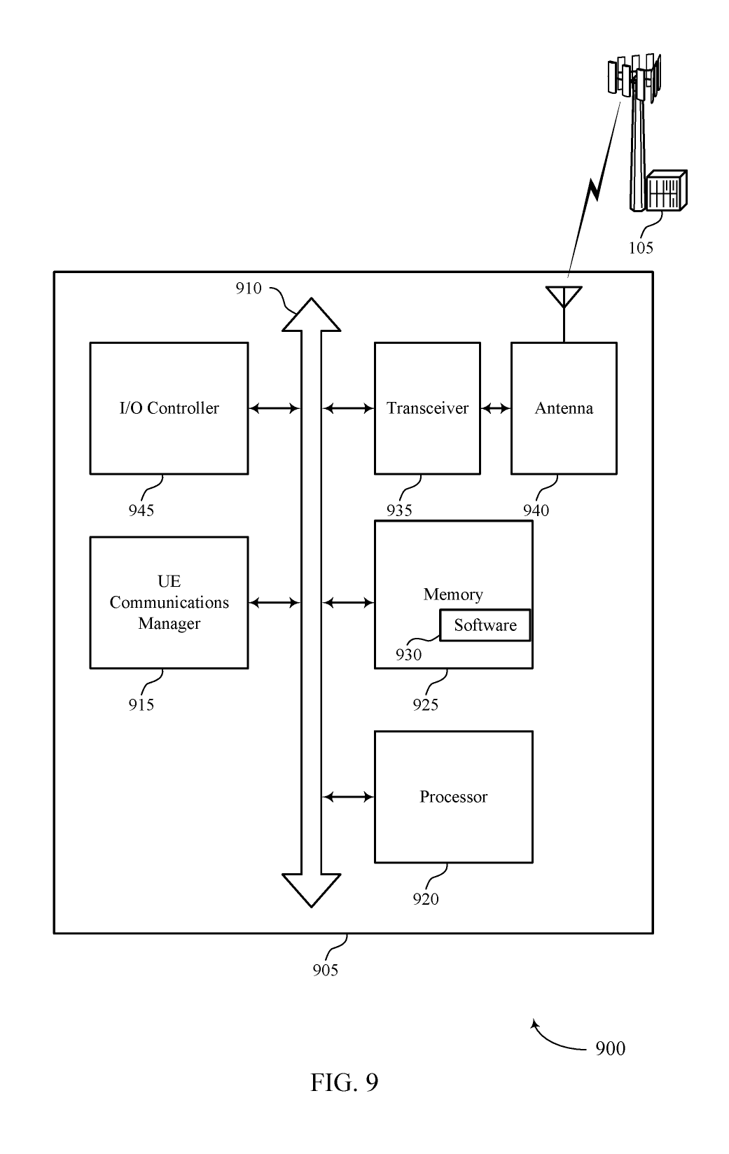

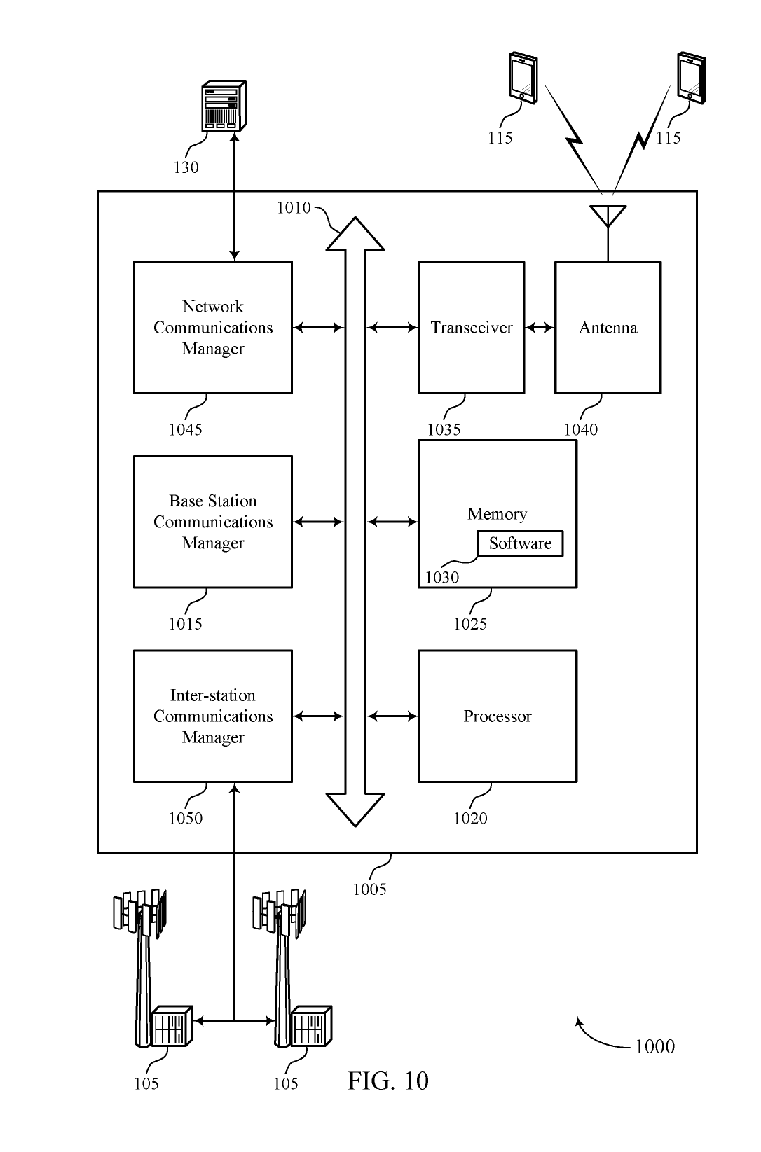

Receiver 710 may receive information such as packets, user data, or control information associated with various information channels (e.g., control channels, data channels, and information related to repetition-based transmissions and HARQ retransmissions, etc.). Information may be passed on to other components of the device. The receiver 710 may be an example of aspects of the transceiver 935 or the transceiver 1035 described with reference to FIGS. 9 and 10. The receiver 710 may utilize a single antenna or a set of antennas.

Communications manager 715 may be an example of aspects of the communications manager 915 or the communications manager 1015 described with reference to FIGS. 9 and 10. Communications manager 715 and/or at least some of its various sub-components may be implemented in hardware, software executed by a processor, firmware, or any combination thereof. If implemented in software executed by a processor, the functions of the communications manager 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 715 and/or at least some of its various sub-components may be physically located at various positions, including being distributed such that portions of functions are implemented at different physical locations by one or more physical devices. In some examples, communications manager 715 and/or at least some of its various sub-components may be a separate and distinct component in accordance with various aspects of the present disclosure. In other examples, communications manager 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 715 may identify one or more TTIs allocated for a transmission of a transport block, transmit a set of copies of the transport block on resources of the one or more TTIs, receive feedback indicating that at least one copy of the set of copies of the transport block was not successfully decoded, and retransmit one or more copies of the transport block based on receiving the feedback. The communications manager 715 may also identify one or more TTIs allocated for a transmission of a transport block, receive a set of copies of the transport block on resources of the one or more TTIs, attempt to decode each of the set of copies of the transport block, transmit feedback indicating that at least one copy of the set of copies of the transport block was not successfully decoded, and receive a retransmission of one or more copies of the transport block based on transmitting the feedback.

Transmitter 720 may transmit signals generated by other components of the device. In some examples, the transmitter 720 may be collocated with a receiver 710 in a transceiver module. For example, the transmitter 720 may be an example of aspects of the transceiver 935 or the transceiver 1035 described with reference to FIGS. 9 and 10. The transmitter 720 may utilize a single antenna or a set of antennas.

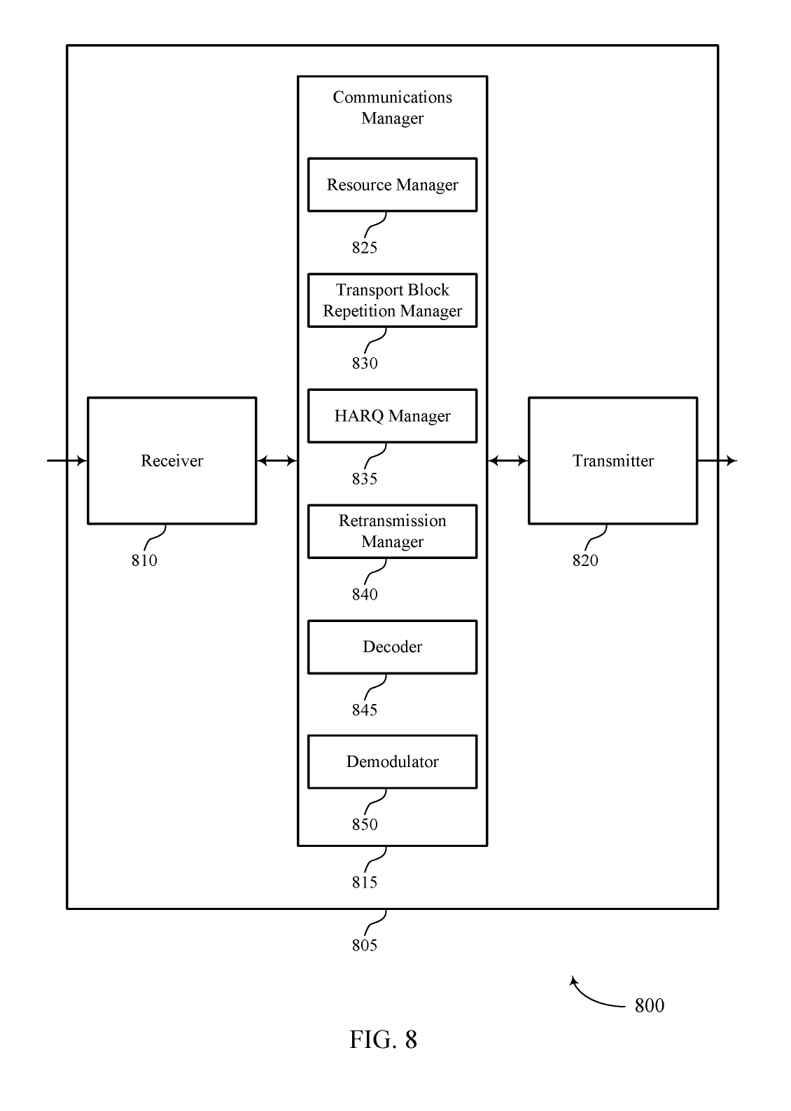

FIG. 8 shows a block diagram 800 of a wireless device 805 that supports repetition-based transmissions and HARQ retransmissions in accordance with aspects of the present disclosure. Wireless device 805 may be an example of aspects of a wireless device 705 or a UE 115 or base station 105 as described with reference to FIG. 7. Wireless device 805 may include receiver 810, communications manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to repetition-based transmissions and HARQ retransmissions, etc.). Information may be passed on to other components of the device. The receiver 810 may be an example of aspects of the transceiver 935 or the transceiver 1035 described with reference to FIGS. 9 and 10. The receiver 810 may utilize a single antenna or a set of antennas.

Communications manager 815 may be an example of aspects of the communications manager 915 or the communications manager 1015 described with reference to FIGS. 9 and 10. Communications manager 815 may include resource manager 825, transport block repetition manager 830, HARQ manager 835, retransmission manager 840, decoder 845, and demodulator 850.

In some aspects, resource manager 825 may identify one or more TTIs allocated for a transmission of a transport block, and transport block repetition manager 830 may transmit a set of copies of the transport block on resources of the one or more TTIs. HARQ manager 835 may receive feedback indicating that at least one copy of the set of copies of the transport block was not successfully decoded, and retransmission manager 840 may retransmit one or more copies of the transport block based on receiving the feedback. In some cases, transmitting the set of copies of the transport block on resources of the one or more TTIs includes transmitting the set of copies of the transport block on resources of a single TTI, where each copy of the set of copies of the transport block is transmitted on resources of a group of one or more symbols in the single TTI. In some cases, a duration after which the feedback is received after transmitting the at least one copy of the transport block is based on a number of symbols in each group of one or more symbols used to transmit the at least one copy of the transport block.

In some cases, each copy of the transport block transmitted on resources of a group of one or more symbols is self-decodable. In some cases, a transmission of a first copy of the transport block on resources of a first group of one or more symbols is scheduled or configured differently from a transmission of a second copy of the transport block on resources of a second group of one or more symbols. In some cases, the different scheduling or the different configuration includes a different resource allocation, a different redundancy version, a different MCS, or a combination thereof.

In some cases, receiving the feedback includes receiving the feedback in a transmission that spans all symbols in a TTI subsequent to the one or more TTIs. In some cases, receiving the feedback includes receiving the feedback in a transmission that spans a subset of symbols in a TTI subsequent to the one or more TTIs. In some cases, the TTI subsequent to the one or more TTIs includes a three-symbol TTI, and the feedback and a grant for retransmitting the one or more copies of the transport block is received in a last symbol of the three-symbol TTI.

In some cases, HARQ manager 835 may receive feedback indicating that at least one of the retransmitted copies of the transport block was successfully decoded. In some cases, the feedback indicating that the at least one of the retransmitted copies of the transport block was successfully decoded includes a CSI report.

In some cases, demodulator 850 may demodulate the CSI report based on a channel estimate, wherein the channel estimate is determined based on previously received feedback indicating that at least one of the retransmitted copies of the transport block was not successfully decoded.

In some cases, HARQ manager 835 may receive feedback indicating that at least one of the retransmitted copies of the transport block was not successfully decoded, wherein the feedback is received on a same set of resources as a CSI report. In some cases, demodulator 850 may demodulate the CSI report based on a channel estimate, the channel estimate determined based on the feedback indicating that the at least one of the retransmitted copies of the transport block was not successfully decoded.

In other aspects, resource manager 825 may identify one or more TTIs allocated for a transmission of a transport block, and transport block repetition manager 830 may receive a set of copies of the transport block on resources of the one or more TTIs. Decoder 845 may attempt to decode each of the set of copies of the transport block, and, in some cases, may fail to decode each of the set of copies of the transport block. Accordingly, HARQ manager 835 may transmit feedback indicating that at least one copy of the plurality of copies of the transport block was not successfully decoded, and retransmission manager 840 may receive a retransmission of one or more copies of the transport block based on transmitting the feedback.

In some cases, receiving the set of copies of the transport block on resources of the one or more TTIs includes receiving the set of copies of the transport block on resources of a single TTI, where each copy of the set of copies of the transport block is received on resources of a group of one or more symbols in the single TTI. In some cases, a duration after which the feedback is transmitted after receiving the at least one copy of the transport block is based on a number of symbols in each group of one or more symbols used to transmit the at least one copy of the transport block.

In some cases, each copy of the transport block received on resources of a group of one or more symbols is self-decodable. In some cases, a transmission of a first copy of the transport block received on resources of a first group of one or more symbols is scheduled differently from a transmission of a second copy of the transport block received on resources of a second group of one or more symbols. In some cases, the different scheduling includes a different resource allocation, a different redundancy version, a different MCS, or some combination thereof.

In some cases, a transmission of a first copy of the transport block received on resources of a first group of one or more symbols is configured differently from a transmission of a second copy of the transport block received on resources of a second group of one or more symbols. In some cases, the different configuration includes a different resource allocation, a different redundancy version, a different MCS, or some combination thereof.

In some cases, transmitting the feedback includes transmitting the feedback in a transmission that spans all symbols in a TTI subsequent to the one or more TTIs. In some cases, transmitting the feedback includes transmitting the feedback in a transmission that spans a subset of symbols in a TTI subsequent to the one or more TTIs. In some cases, the TTI subsequent to the one or more TTIs includes a three-symbol TTI, and the feedback and a grant for the retransmission of the one or more copies of the transport block is transmitted in a last symbol of the three-symbol TTI.

In some cases, resource manager 825 may transmit an uplink grant in a PDCCH for the retransmission of the one or more copies of the transport block. In some cases, HARQ manager 835 may transmit feedback indicating that at least one of the retransmitted copies of the transport block was successfully decoded. In some cases, the feedback indicating that the at least one of the retransmitted copies of the transport block was successfully decoded includes a CSI report. In some cases, HARQ manager 835 may transmit feedback indicating that at least one of the retransmitted copies of the transport block was not successfully decoded, wherein the feedback is transmitted on a same set of resources as a CSI report.

Transmitter 820 may transmit signals generated by other components of the device. In some examples, the transmitter 820 may be collocated with a receiver 810 in a transceiver module. For example, the transmitter 820 may be an example of aspects of the transceiver 935 or the transceiver 1035 described with reference to FIGS. 9 and 10. The transmitter 820 may utilize a single antenna or a set of antennas.

FIG. 9 shows a diagram of a system 900 including a device 905 that supports repetition-based transmissions and HARQ retransmissions in accordance with aspects of the present disclosure. Device 905 may be an example of or include the components of wireless device 705, wireless device 805, or a UE 115 as described above, e.g., with reference to FIGS. 7 and 8. Device 905 may include components for bi-directional voice and data communications including components for transmitting and receiving communications, including UE communications manager 915, processor 920, memory 925, software 930, transceiver 935, antenna 940, and I/O controller 945. These components may be in electronic communication via one or more buses (e.g., bus 910). Device 905 may communicate wirelessly with one or more base stations 105.

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting repetition-based transmissions and HARQ retransmissions).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support repetition-based transmissions and HARQ retransmissions. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

FIG. 10 shows a diagram of a system 1000 including a device 1005 that supports repetition-based transmissions and HARQ retransmissions in accordance with aspects of the present disclosure. Device 1005 may be an example of or include the components of wireless device 705, wireless device 805, or a base station 105 as described above, e.g., with reference to FIGS. 7 and 8. Device 1005 may include components for bi-directional voice and data communications including components for transmitting and receiving communications, including base station communications manager 1015, processor 1020, memory 1025, software 1030, transceiver 1035, antenna 1040, network communications manager 1045, and inter-station communications manager 1050. These components may be in electronic communication via one or more buses (e.g., bus 1010). Device 1005 may communicate wirelessly with one or more UEs 115.

Processor 1020 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting repetition-based transmissions and HARQ retransmissions).

Memory 1025 may include RAM and ROM. The memory 1025 may store computer-readable, computer-executable software 1030 including instructions that, when executed, cause the processor to perform various functions described herein. In some cases, the memory 1025 may contain, among other things, a BIOS which may control basic hardware or software operation such as the interaction with peripheral components or devices.

Software 1030 may include code to implement aspects of the present disclosure, including code to support repetition-based transmissions and HARQ retransmissions. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

Network communications manager 1045 may manage communications with the core network (e.g., via one or more wired backhaul links). For example, the network communications manager 1045 may manage the transfer of data communications for client devices, such as one or more UEs 115.

Inter-station communications manager 1050 may manage communications with other base station 105, and may include a controller or scheduler for controlling communications with UEs 115 in cooperation with other base stations 105. For example, the inter-station communications manager 1050 may coordinate scheduling for transmissions to UEs 115 for various interference mitigation techniques such as beamforming or joint transmission. In some examples, inter-station communications manager 1050 may provide an X2 interface within an LTE/LTE-A wireless communication network technology to provide communication between base stations 105.

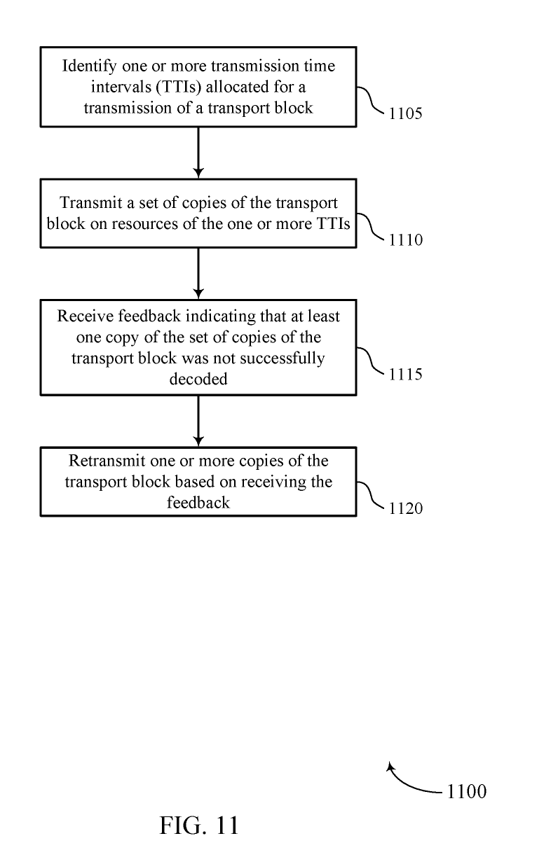

FIG. 11 shows a flowchart illustrating a method 1100 for repetition-based transmissions and HARQ retransmissions in accordance with aspects of the present disclosure. The operations of method 1100 may be implemented by a UE 115 or base station 105 or its components as described herein. For example, the operations of method 1100 may be performed by a communications manager as described with reference to FIGS. 7 and 8. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At 1105, the UE 115 or base station 105 may identify one or more TTIs allocated for a transmission of a transport block. The operations of 1105 may be performed according to the methods described herein. In certain examples, aspects of the operations of 1105 may be performed by a resource manager as described with reference to FIGS. 7 and 8.

At 1110, the UE 115 or base station 105 may transmit a plurality of copies of the transport block on resources of the one or more TTIs. In some cases, the UE 115 or base station 105 may transmit a plurality of copies of the transport block in a single TTI. In one example, the single TTI may be a two-symbol sTTI or a three-symbol sTTI, and each copy of the transport block may be transmitted in a symbol in the sTTI.

In another example, the single TTI may be a one-slot sTTI, and each copy of the transport block may be transmitted in a group of two or three symbols in the one-slot sTTI. In yet another example, the single TTI may be a subframe, and each copy of the transport block may be transmitted in a group of two or three symbols in the subframe, or in a slot of the subframe (e.g., a group of seven symbols). The operations of 1110 may be performed according to the methods described herein. In certain examples, aspects of the operations of 1110 may be performed by a transport block repetition manager as described with reference to FIGS. 7 and 8.

At 1115, the UE 115 or base station 105 may receive feedback indicating that at least one copy of the plurality of copies of the transport block was not successfully decoded. In some cases, the timing of the HARQ feedback for the at least one copy of the transport block (e.g., the time taken to process the at least one copy of the transport block) may be based on the number of symbols in a group of symbols used to transmit the at least one copy of the transport block.

In one example, if the at least one copy of the transport block was transmitted in one symbol, the time taken to process the at least one copy of the transport block may span four symbols. In another example, if the at least one copy of the transport block was transmitted in groups of two or three symbols, the time taken to process the at least one copy of the transport block may span four groups of two or three symbols. In yet another example, if the at least one copy of the transport block was transmitted in a slot, the time taken to process the at least one copy of the transport block may span four slots. The operations of 1115 may be performed according to the methods described herein. In certain examples, aspects of the operations of 1115 may be performed by a HARQ manager as described with reference to FIGS. 7 and 8.

At 1120, the UE 115 or base station 105 may retransmit one or more copies of the transport block based at least in part on receiving the feedback. Similar to the HARQ timing discussed above, the timing of the retransmission for the one or more copies of the transport block may be based on a number of symbols in a group of symbols used to transmit an original copy of the transport block. In one example, if the original copy of the transport block was transmitted in one symbol, the time taken to retransmit the transport block after receiving the HARQ feedback may span four symbols. In another example, if the original copy of the transport block was transmitted in groups of two or three symbols, the time taken to retransmit the transport block after receiving the HARQ feedback may span four groups of two or three symbols. In yet another example, if the original copy of the transport block was transmitted in a slot, the time taken to retransmit the transport block after receiving the HARQ feedback may span four slots. The operations of 1120 may be performed according to the methods described herein. In certain examples, aspects of the operations of 1120 may be performed by a retransmission manager as described with reference to FIGS. 7 and 8.

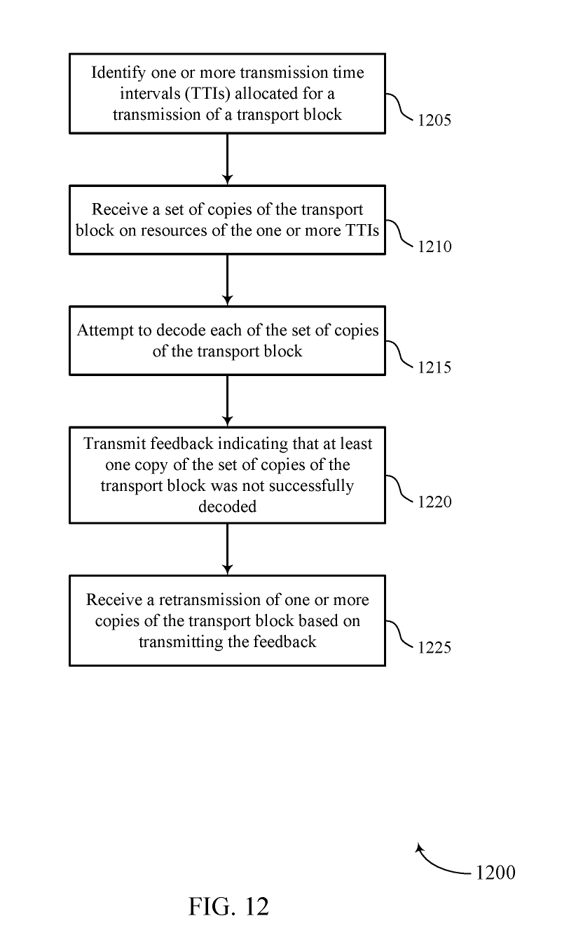

FIG. 12 shows a flowchart illustrating a method 1200 for repetition-based transmissions and HARQ retransmissions in accordance with aspects of the present disclosure. The operations of method 1200 may be implemented by a UE 115 or base station 105 or its components as described herein. For example, the operations of method 1200 may be performed by a communications manager as described with reference to FIGS. 7 and 8. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At 1205, the UE 115 or base station 105 may identify one or more TTIs allocated for a transmission of a transport block. The operations of 1205 may be performed according to the methods described herein. In certain examples, aspects of the operations of 1205 may be performed by a resource manager as described with reference to FIGS. 7 and 8.

At 1210, the UE 115 or base station 105 may receive a plurality of copies of the transport block on resources of the one or more TTIs. In some cases, the UE 115 or base station 105 may receive a plurality of copies of the transport block in a single TTI. In one example, the single TTI may be a two-symbol sTTI or a three-symbol sTTI, and each copy of the transport block may be received in a symbol in the sTTI. In another example, the single TTI may be a one-slot sTTI, and each copy of the transport block may be received in a group of two or three symbols in the one-slot sTTI. In yet another example, the single TTI may be a subframe, and each copy of the transport block may be received in a group of two or three symbols in the subframe or in a slot of the subframe (e.g., a group of seven symbols). The operations of 1210 may be performed according to the methods described herein. In certain examples, aspects of the operations of 1210 may be performed by a transport block repetition manager as described with reference to FIGS. 7 and 8.

At 1215, the UE 115 or base station 105 may attempt to decode each of the plurality of copies of the transport block. The operations of 1215 may be performed according to the methods described herein. In certain examples, aspects of the operations of 1215 may be performed by a decoder as described with reference to FIGS. 7 and 8.

At 1220, the UE 115 or base station 105 may transmit feedback indicating that at least one copy of the plurality of copies of the transport block was not successfully decoded. In some cases, the timing of the HARQ feedback for the at least one copy of the transport block (e.g., the time taken to process the at least one copy of the transport block) may be based on the number of symbols in a group of symbols in which the at least one copy of the transport block was received.

In one example, if the at least one copy of the transport block was received in one symbol, the time taken to process the at least one copy of the transport block may span four symbols. In another example, if the at least one copy of the transport block was received in groups of two or three symbols, the time taken to process the at least one copy of the transport block may span four groups of two or three symbols. In yet another example, if the at least one copy of the transport block was received in a slot, the time taken to process the at least one copy of the transport block may span four slots. The operations of 1220 may be performed according to the methods described herein. In certain examples, aspects of the operations of 1220 may be performed by a HARQ manager as described with reference to FIGS. 7 and 8.

At 1225, the UE 115 or base station 105 may receive a retransmission of one or more copies of the transport block based at least in part on transmitting the feedback. Similar to the HARQ timing discussed above, the timing of the retransmission for the one or more copies of the transport block may be based on a number of symbols in a group of symbols in which an original copy of the transport block was received. In one example, if the original copy of the transport block was received in one symbol, the time taken to receive the retransmission of the transport block after transmitting the HARQ feedback may span four symbols. In another example, if the original copy of the transport block was received in groups of two or three symbols, the time taken to receive the retransmission of the transport block after transmitting the HARQ feedback may span four groups of two or three symbols. In yet another example, if the original copy of the transport block was received in a slot, the time taken to receive the retransmission of the transport block after transmitting the HARQ feedback may span four slots. The operations of 1225 may be performed according to the methods described herein. In certain examples, aspects of the operations of 1225 may be performed by a retransmission manager as described with reference to FIGS. 7 and 8.

In some examples of the method, apparatus, and non-transitory computer-readable medium described above, transmitting the plurality of copies of the transport block on resources of the one or more TTIs includes transmitting the plurality of copies of the transport block on resources of a single TTI, where each copy of the plurality of copies of the transport block may be transmitted on resources of a group of one or more symbols in the single TTI. In some examples of the method, apparatus, and non-transitory computer-readable medium described above, a duration after which the feedback may be received after transmitting the at least one copy of the transport block may be based at least in part on a number of symbols in each group of one or more symbols used to transmit the at least one copy of the transport block. In some examples of the method, apparatus, and non-transitory computer-readable medium described above, each copy of the transport block may be transmitted on resources of a group of one or more symbols may be self-decodable.

In some examples of the method, apparatus, and non-transitory computer-readable medium described above, a transmission of a first copy of the transport block on resources of a first group of one or more symbols may be scheduled or configured differently from a transmission of a second copy of the transport block on resources of a second group of one or more symbols. In some examples of the method, apparatus, and non-transitory computer-readable medium described above, the different scheduling or the different configuration includes a different resource allocation, a different redundancy version, a different modulation and coding scheme (MCS), or some combination thereof.

In some examples of the method, apparatus, and non-transitory computer-readable medium described above, receiving the feedback includes receiving the feedback in a transmission that spans all symbols in a TTI subsequent to the one or more TTIs. In some examples of the method, apparatus, and non-transitory computer-readable medium described above, receiving the feedback includes receiving the feedback in a transmission that spans a subset of symbols in a TTI subsequent to the one or more TTIs. In some examples of the method, apparatus, and non-transitory computer-readable medium described above, the TTI subsequent to the one or more TTIs includes a three-symbol TTI, and the feedback and a grant for retransmitting the one or more copies of the transport block may be received in a last symbol of the three-symbol TTI.

Some examples of the method, apparatus, and non-transitory computer-readable medium described above may further include processes, features, means, or instructions for receiving feedback indicating that at least one of the retransmitted copies of the transport block was successfully decoded. In some examples of the method, apparatus, and non-transitory computer-readable medium described above, the feedback indicating that the at least one of the retransmitted copies of the transport block was successfully decoded includes a channel state information (CSI) report. Some examples of the method, apparatus, and non-transitory computer-readable medium described above may further include processes, features, means, or instructions for demodulating the CSI report based at least in part on a channel estimate, the channel estimate determined based at least in part on previously received feedback indicating that at least one of the retransmitted copies of the transport block was not successfully decoded.

Some examples of the method, apparatus, and non-transitory computer-readable medium described above may further include processes, features, means, or instructions for receiving feedback indicating that at least one of the retransmitted copies of the transport block was not successfully decoded, where the feedback is received on a same set of resources as a CSI report. Some examples of the method, apparatus, and non-transitory computer-readable medium described above may further include processes, features, means, or instructions for demodulating the CSI report based on a channel estimate, the channel estimate determined based on the feedback indicating that the at least one of the retransmitted copies of the transport block was not successfully decoded.

In some examples of the method, apparatus, and non-transitory computer-readable medium described above, receiving the plurality of copies of the transport block on resources of the one or more TTIs includes receiving the plurality of copies of the transport block on resources of a single TTI, where each copy of the plurality of copies of the transport block may be received on resources of a group of one or more symbols in the single TTI. In some examples of the method, apparatus, and non-transitory computer-readable medium described above, a duration after which the feedback may be transmitted after receiving the at least one copy of the transport block may be based at least in part on a number of symbols in each group of one or more symbols used to transmit the at least one copy of the transport block. In some examples of the method, apparatus, and non-transitory computer-readable medium described above, each copy of the transport block received on resources of a group of one or more symbols may be self-decodable.

In some examples of the method, apparatus, and non-transitory computer-readable medium described above, a transmission of a first copy of the transport block received on resources of a first group of one or more symbols may be scheduled or configured differently from a transmission of a second copy of the transport block received on resources of a second group of one or more symbols. In some examples of the method, apparatus, and non-transitory computer-readable medium described above, the different scheduling or the different configuration includes a different resource allocation, a different redundancy version, a different MCS, or some combination thereof.

In some examples of the method, apparatus, and non-transitory computer-readable medium described above, transmitting the feedback includes transmitting the feedback in a transmission that spans all symbols in a TTI subsequent to the one or more TTIs. In some examples of the method, apparatus, and non-transitory computer-readable medium described above, transmitting the feedback includes transmitting the feedback in a transmission that spans a subset of symbols in a TTI subsequent to the one or more TTIs. In some examples of the method, apparatus, and non-transitory computer-readable medium described above, the TTI subsequent to the one or more TTIs includes a three-symbol TTI, and the feedback and a grant for the retransmission of the one or more copies of the transport block may be transmitted in a last symbol of the three-symbol TTI. Some examples of the method, apparatus, and non-transitory computer-readable medium described above may further include processes, features, means, or instructions for transmitting an uplink grant in a physical downlink control channel (PDCCH) for the retransmission of the one or more copies of the transport block.

Some examples of the method, apparatus, and non-transitory computer-readable medium described above may further include processes, features, means, or instructions for transmitting feedback indicating that at least one of the retransmitted copies of the transport block was successfully decoded. In some examples of the method, apparatus, and non-transitory computer-readable medium described above, the feedback indicating that the at least one of the retransmitted copies of the transport block was successfully decoded includes a CSI report. Some examples of the method, apparatus, and non-transitory computer-readable medium described above may further include processes, features, means, or instructions for transmitting feedback indicating that at least one of the retransmitted copies of the transport block was not successfully decoded, where the feedback is transmitted on a same set of resources as a CSI report.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying one or more transmission time intervals (TTIs) allocated for a transmission of a transport block;
transmitting a plurality of copies of the transport block on resources of the one or more TTIs;
receiving feedback indicating that at least one copy of the plurality of copies of the transport block was not successfully decoded; and
retransmitting one or more copies of the transport block based at least in part on receiving the feedback.

2. The method of claim 1, wherein transmitting the plurality of copies of the transport block on resources of the one or more TTIs comprises:
transmitting the plurality of copies of the transport block on resources of a single TTI, wherein each copy of the plurality of copies of the transport block is transmitted on resources of a group of one or more symbols in the single TTI.

3. The method of claim 2, wherein a duration after which the feedback is received after transmitting the at least one copy of the transport block is based at least in part on a number of symbols in each group of one or more symbols used to transmit the at least one copy of the transport block.

4. The method of claim 2, wherein each copy of the transport block transmitted on resources of a group of one or more symbols is self-decodable.

5. The method of claim 2, wherein a transmission of a first copy of the transport block on resources of a first group of one or more symbols is scheduled or configured differently from a transmission of a second copy of the transport block on resources of a second group of one or more symbols.

6. The method of claim 5, wherein the different scheduling or the different configuration comprises a different resource allocation, a different redundancy version, a different modulation and coding scheme (MCS), or some combination thereof.

7. The method of claim 1, wherein receiving the feedback comprises:
receiving the feedback in a transmission that spans all symbols in a TTI subsequent to the one or more TTIs.

8. The method of claim 1, wherein receiving the feedback comprises:
receiving the feedback in a transmission that spans a subset of symbols in a TTI subsequent to the one or more TTIs.

9. The method of claim 8, wherein the TTI subsequent to the one or more TTIs comprises a three-symbol TTI, and the feedback and a grant for retransmitting the one or more copies of the transport block is received in a last symbol of the three-symbol TTI.

10. The method of claim 1, further comprising:
receiving feedback indicating that at least one of the retransmitted copies of the transport block was successfully decoded.

11. The method of claim 10, wherein the feedback indicating that the at least one of the retransmitted copies of the transport block was successfully decoded comprises a channel state information (CSI) report.

12. The method of claim 11, further comprising:
demodulating the CSI report based at least in part on a channel estimate, the channel estimate determined based at least in part on previously received feedback indicating that at least one of the retransmitted copies of the transport block was not successfully decoded.

13. The method of claim 1, further comprising:
receiving feedback indicating that at least one of the retransmitted copies of the transport block was not successfully decoded, wherein the feedback is received on a same set of resources as a channel state information (CSI) report.

14. The method of claim 13, further comprising:
demodulating the CSI report based at least in part on a channel estimate, the channel estimate determined based at least in part on the feedback indicating that the at least one of the retransmitted copies of the transport block was not successfully decoded.

15. A method for wireless communication, comprising:
identifying one or more transmission time intervals (TTIs) allocated for a transmission of a transport block;
receiving a plurality of copies of the transport block on resources of the one or more TTIs;
attempting to decode each of the plurality of copies of the transport block;
transmitting feedback indicating that at least one copy of the plurality of copies of the transport block was not successfully decoded; and
receiving a retransmission of one or more copies of the transport block based at least in part on transmitting the feedback.

16. The method of claim 15, wherein receiving the plurality of copies of the transport block on resources of the one or more TTIs comprises:
receiving the plurality of copies of the transport block on resources of a single TTI, wherein each copy of the plurality of copies of the transport block is received on resources of a group of one or more symbols in the single TTI.

17. The method of claim 16, wherein a duration after which the feedback is transmitted after receiving the at least one copy of the transport block is based at least in part on a number of symbols in each group of one or more symbols used to transmit the at least one copy of the transport block.

18. The method of claim 16, wherein each copy of the transport block received on resources of a group of one or more symbols is self-decodable.

19. The method of claim 16, wherein a transmission of a first copy of the transport block received on resources of a first group of one or more symbols is scheduled or configured differently from a transmission of a second copy of the transport block received on resources of a second group of one or more symbols.

20. The method of claim 19, wherein the different scheduling or the different configuration comprises a different resource allocation, a different redundancy version, a different modulation and coding scheme (MCS), or some combination thereof.

21. The method of claim 15, wherein transmitting the feedback comprises:
transmitting the feedback in a transmission that spans all symbols in a TTI subsequent to the one or more TTIs.

22. The method of claim 15, wherein transmitting the feedback comprises:
transmitting the feedback in a transmission that spans a subset of symbols in a TTI subsequent to the one or more TTIs.

23. The method of claim 22, wherein the TTI subsequent to the one or more TTIs comprises a three-symbol TTI, and the feedback and a grant for the retransmission of the one or more copies of the transport block is transmitted in a last symbol of the three-symbol TTI.

24. The method of claim 15, further comprising:
transmitting an uplink grant in a physical downlink control channel (PDCCH) for the retransmission of the one or more copies of the transport block.

25. The method of claim 15, further comprising:
transmitting feedback indicating that at least one of the retransmitted copies of the transport block was successfully decoded.

26. The method of claim 25, wherein the feedback indicating that the at least one of the retransmitted copies of the transport block was successfully decoded comprises a channel state information (CSI) report.

27. The method of claim 15, further comprising:
transmitting feedback indicating that at least one of the retransmitted copies of the transport block was not successfully decoded, wherein the feedback is transmitted on a same set of resources as a channel state information (CSI) report.

28. An apparatus for wireless communication, comprising:
a processor;
memory in electronic communication with the processor; and
instructions stored in the memory and executable by the processor to cause the apparatus to:
identify one or more transmission time intervals (TTIs) allocated for a transmission of a transport block;
transmit a plurality of copies of the transport block on resources of the one or more TTIs;
receive feedback indicating that at least one copy of the plurality of copies of the transport block was not successfully decoded; and
retransmit one or more copies of the transport block based at least in part on receiving the feedback.

29. The apparatus of claim 28, wherein the instructions to transmit the plurality of copies of the transport block on resources of the one or more TTIs are executable by the processor to cause the apparatus to:
transmit the plurality of copies of the transport block on resources of a single TTI, wherein each copy of the plurality of copies of the transport block is transmitted on resources of a group of one or more symbols in the single TTI.

30. An apparatus for wireless communication, comprising:
a processor;
memory in electronic communication with the processor; and
instructions stored in the memory and executable by the processor to cause the apparatus to:
identify one or more transmission time intervals (TTIs) allocated for a transmission of a transport block;
receive a plurality of copies of the transport block on resources of the one or more TTIs;
attempt to decode each of the plurality of copies of the transport block;
transmit feedback indicating that at least one copy of the plurality of copies of the transport block was not successfully decoded; and
receive a retransmission of one or more copies of the transport block based at least in part on transmitting the feedback.
